(19) United States
(12) Patent Application Publication
(10) Pub. No.: US 2004/0054670 A1
(43) Pub. Date: Mar. 18, 2004

(54) Dynamic object type for information management and real time graphic collaboration

(76) Inventors: Jacob Noff, Herzlia (IL); Eliezer Segalowitz, Herzlia (IL); David Dolev-Liptz, Or Yehuda (IL)

Correspondence Address: Bill Polkinghorn, Mark Friedman Ltd, Discovery Dispatch, 9003 Florin Way, Upper Marlboro, MD, 20772, US

(21) Appl. No.: 10/467,214

(22) PCT Filed: Feb. 6, 2002
(86) PCT No.: PCT/IL02/00100

(30) Foreign Application Priority Data
Feb. 7, 2001 (US) 60266881

(51) Int. Cl. G06F 17/30

(52) U.S. Cl. 707/3

(57) ABSTRACT

The creation and management of a new dynamic object format referred to as an Information Graphic Object (IGO). The IGO enables intuitive capturing, managing and sharing of dynamic content. These objects may be created manually using a conventional mouse, or automatically using an “Automatic Scan Manager (ASM) Engine”. The ASM includes an Article Recognition Engine” (ARE™) for capturing actual articles, with multiple formats, from a plurality of content sources simultaneously. These articles are converted into IGO and can be subsequently manipulated, managed and shared with other users. The IGO are dynamic objects that can be sent to other users using the Player 2 Player (PL2PL) capabilities of the system. These capabilities furthermore enable graphic chatting in real time. The IGO can also be stored with their live properties, whereupon extraction of an IGO from an IGO gallery activates the live properties.

### FIELD AND BACKGROUND OF THE INVENTION

1. Field of the Invention

The present invention relates to a system and method for information management and communication. In particular, the present invention provides a tool for researching, communicating and collaborating, by providing intuitive information searching, capturing and management of dynamic information graphic objects.

2. Description of the Related Art

The need for research and information management tools for users of data networks has become increasingly important, following the massive quantities of information available on these networks. Various tools are currently offered to aid users of such information, such as: Automatic Capturing of information, such as scanning of Web or other pages; Text matching engines, such as Autonomy (www.autonomy.com) that employs advanced pattern matching technology (non-linear adaptive digital signal processing) to determine the characteristics that give the text meaning, and Textology (www.textology.com) that analyze text of various lengths, sources and contexts, in order to yield relevant results; User Alerts, such as the technologies of Netmind (http://www.pumatech.com/mind-it_service/service.html) and Alerts (http://www.alerts.com), which alert their users in response to general changes of web pages; Capture information, which provides the capability to select text information and/or pictures and save it to a disk file; and standardized email software that enables saving and sending of files as attachments.

The above mentioned technologies typically enable capturing and usage of files by network users, however the nature of these files and their usage are typically limited in ways such as: The files are typically useable only when opened up by applications as attachments; they typically do not enable usage of dynamic information (that may change in real time); typically do not recognize actual content of the files and are therefore non-intuitive to use; these files, even where constructed as objects, do not typically enable manipulation of these objects with their various dynamic properties, such as graphic signs, graphic alerts, graphic chat sharing and capture text matching; captured information cannot typically be shared and updated in a real time way; partial information (not entire files) cannot typically be captured with its various properties; shared and managed; users cannot typically execute graphic chatting over captured information objects.

There is thus a widely recognized need for, and it would be highly advantageous to have, a type of multi-format object that is intuitively created from content sources, and can be updated and shared between users in real time. Furthermore, there is a need to enable an easy, preferably automatic means of creating such an object. Moreover, there is a need to enable online collaboration using such an object, such that the object will function as a fully interactive object in real time.

### SUMMARY OF THE INVENTION

The present invention provides a system and method for intuitive information searching, capturing, management and sharing, using a new file format, referred to hereinafter as an “Information Graphic Object(s)” (IGO). The present invention enables an intuitive way of simultaneously searching a variety of network based content sources for relevant information, and the automatic capturing of the relevant information, in the form of complete information articles. These articles are subsequently converted into IGO. These IGO capture the content of the information, whether in single or multiple data formats (for example, an article that includes both graphic and textual components).

The IGO have a file format that contains compressed images, the text of the image (if applicable), URL (if applicable), key words and other properties (for example the time of capture, link information, source information etc.). The text and other properties can be extracted automatically from Web pages, Word documents, PDF documents, Email documents or any other document types. In addition, the user can add, delete and update properties manually. After creating the IGO, the object can be used for manipulating, storing, retrieving, sharing and real time collaboration with other users using the IGO. The IGO content is dynamic, and can be automatically updated according to the original refresh rates of the captured content. All IGO content can be extracted from the IGO in order to be manipulated, retrieved, edited or otherwise used.

The created object can be saved in the server database, retrieved, updated, shared and searched with multilingual capabilities. The captured information (IGO), can be taken from the web, word documents or any other document types, and transformed into a live piece of information on a desktop (with properties). The captured IGO can be shared with other users as objects (via Internet/intranet). The user can add graphic signs (draw, marker, text) over the captured object as a separate layer.

According to a preferred embodiment of the present invention, the changes made to an IGO by a user, whether textual or graphic, can optionally be seen by other connected users in real time, thereby providing a means for enabling real time graphic chatting online. These textual and graphic signs can be moved over the IGO, or edited, manipulated or removed when required.

According to an additional preferred embodiment of the present invention, there is provided a means for scanning of web pages/word documents, such that automatic extraction of articles, as IGO, is enabled. The Automatic Scan Manager (ASM) System achieves this capability by scanning online content, according to the web sites or other documents being used as content sources, as well as “sub-link levels” chosen by the user (all the pages that the sub-links lead to). Found articles are captured and saved as IGO using an Article Recognition Engine (ARE™). The documents scanned, in the case of Web pages, can be selected either from specific web pages (with or without their sub links) or using known search engines to load web pages automatically.

The present invention, furthermore, makes it possible to:

1. Create objects (IGO) manually with multilingual text extraction.

2. Create web articles as objects (IGO) automatically using Article Recognition Engine (ARE™) with multilingual text extraction.

3. Automatic object delivery based on user profile (filters). The delivery can be as IGO object, web page or email.

4. Save articles of IGO with automatic classification in server. Each IGO has properties that include title, text body, key words, marker words, link objects etc.

5. Manage objects in the content server, by storing, updating, retrieving and searching.

6. Delivers IGO (articles) automatically according to matches made with filters, categories and users.

7. Work with small and precise information objects.

8. Share IGO with other users using a Player 2 Player (PL2PL) application.

9. Real time graphic chat (including voice) with other users over a plurality of IGO.

10. Add graphic signs (such as text, markings and drawings) to the object as a separate layer.

11. Proactively execute queries for similar and matched information (either from IGO or user text). The result is a list of IGO from the server, which match the query.

12. Reactively receive advertising IGO according to the user operation.

13. Give live properties to web information objects with refresh rates.

### BRIEF DESCRIPTION OF THE DRAWINGS

The invention is herein described, by way of example only, with reference to the accompanying drawings, wherein:

FIG. 1 illustrates a typical IGO as captured from a Web page.

FIG. 2 illustrates a typical code associated with an IGO, as represented within a tagged XML file.

FIG. 3 illustrates the operational flow when the IGO of FIG. 2 is being created, according to the present invention.

FIG. 4 is an illustration of the system's general architecture, according to the present invention.

FIG. 5 illustrates the manual object capture procedure, according to the present invention.

FIG. 6 is an illustration of the graphic chat procedure, according to the present invention.

FIG. 7 illustrates the operating of the automatic Scan Manager software, according to the present invention.

### DESCRIPTION OF THE PREFERRED EMBODIMENT

The present invention relates to a method for locating, capturing, managing and sharing information, such that users in a data network may share and manipulate multiple-format information in real time.

The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

Specifically, the present invention enables the creation and management of a new dynamic object format, “Information Graphic Object/s” (IGO), which enables intuitive creation, managing and sharing of dynamic content in real time.

The IGO, according to the present invention, can be created manually using a conventional mouse, or any alternative data input device. These objects may also be created automatically using a content scanning system, hereinafter referred to as “Automatic Scan Manager (ASM)” System, wherein content can be located from a plurality of sources simultaneously, and automatically captured, in the form of complete articles, using an “Article Recognition Engine” (ARE™). These tools enable the automatic capture of articles or alternative multiple format content, such that the chosen content can be subsequently manipulated and managed as IGO.

The IGO (the actual IGO, including text, title, image etc.) is compressed and stored in a formatted tagged file. The file contains tags with the relevant image(s), title, texts and additional properties related to the image. Parts of the properties are entered automatically upon capture (intrinsic properties), such as the content's URL, date of creation, body text (if applicable), title of image (if applicable), author name, links to other pages, and any other properties of the captured content. Other properties can be added after capture (personalized properties), such as keywords, comments, title of IGO, marker words, user name, editing dates, keywords, links to other IGO, write access or any other properties given to the IGO.

The principles and operation of a system and a method according to the present invention may be better understood with reference to the drawings and the accompanying description, it being understood that these drawings are given for illustrative purposes only and are not meant to be limiting, wherein:

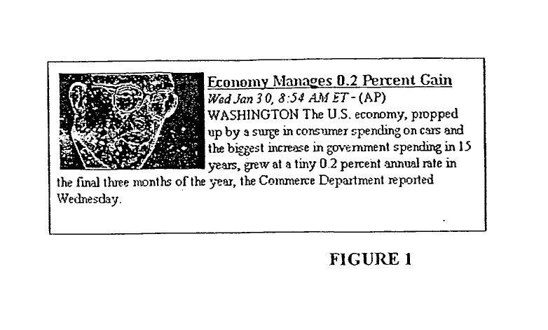

An example of an IGO captured from an article on a Web page can be seen in FIG. 1. As can be seen, the IGO incorporates the article title, picture and text. The IGO of FIG. 1 is a tagged XML file that can be fully manipulated and managed. This file contains within it the article's properties (title, picture, text, refresh properties, source etc.) and optionally additional properties as configured by a user.

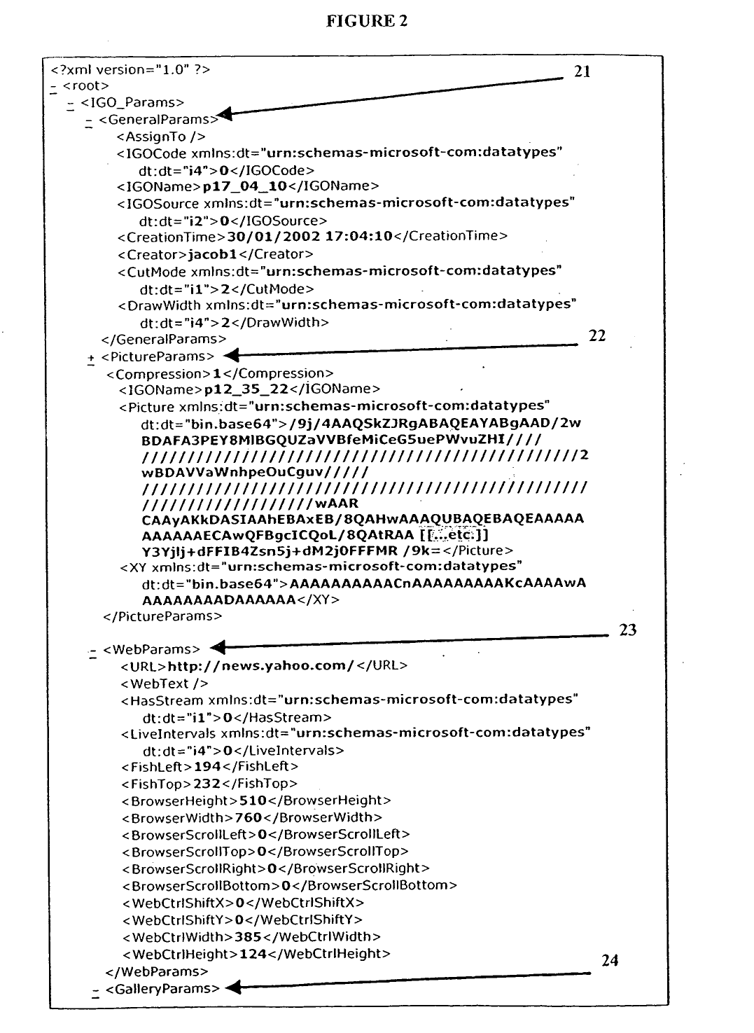

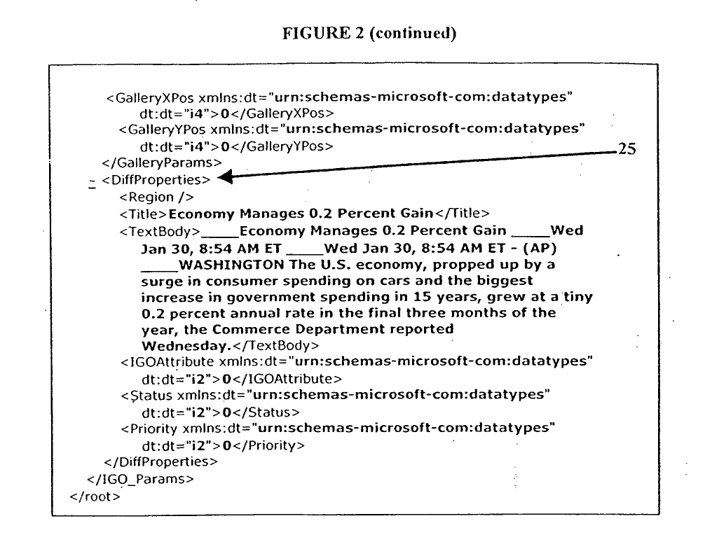

An example of the above IGO, as described in the tagged file, can be seen with reference to FIG. 2. As can be seen, the file contains general parameters 21, such as name, source, creation time, creator, and shape; picture parameters 22 with live intervals, in the case where the IGO is defined as live, with a refresh rate; Web parameters 23, such as URL and refresh intervals; gallery parameters 24, which refers to the location of each IGO inside the gallery; Other properties 25, such as title, other text, and attributes.

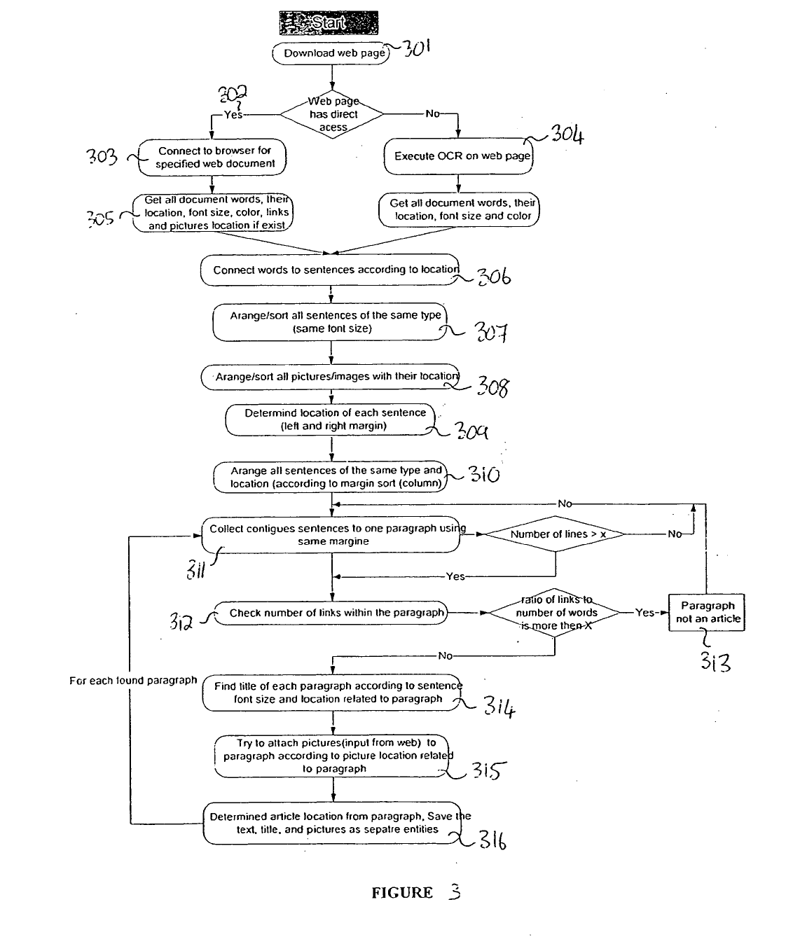

The actual flow of operation by which the system of the present invention automatically creates an IGO can be seen with reference to FIG. 3. As can be seen in the figure, after a Web page has been downloaded 301 to a user's browser (or any other content that the user wants to capture appears on the user's monitor, using any application), the system determines automatically if the page content can be directly accessed or not. This determination is done by using a standard Application Program Interface (API), like a plug-in, which is supported by the application vendor (Microsoft, Adobe etc). If it may be directly accessed 302, the system connects to the actual content using the browser 303, or some other standardized content recognition tool, in order to obtain the document's text, including the locations of words, font sizes, font colors, font type, other font properties, links and picture locations if they exist 305. In the case where the content on the page cannot be directly accessed, the system executes OCR 304 in order to obtain the documenit's words with their locations, font sized and colors etc. The collected words are subsequently connected to sentences 306 according to location, such that she resulting sentences are the combinations of geographically related words (such as within one paragraph). Sentences are then sorted according to font sizes 307, or other font characteristics, in order to differentiate between titles, paragraphs etc. In the case where the article has some picture(s) inside, the next phase requires sorting the picture(s) (which were analyzed when retrieved from the page in step 303) according to location 308: This is in order to ensure that the picture is closely related to the text (this ensures that the capture is an article with intrinsically connected text and images etc.). Once the picture(s) have been analyzed for their positions in respect to the text, the location (left and right margins) of each sentence is determined 309. Following this, all sentences of the same type and location (according to margins i.e. columns) are arranged 310. Contiguous sentences are then collected into single paragraphs 311 using the same margins (sentences that have the same left and right margins) in cases where the articles have a minimal number of lines (so that the articles are of a substantial size). The compiling of paragraphs can refer to deciding which sentences are in the paragraph, as well as reconstructing a paragraph from all relevant sentences. The system can subsequently check the number of links in the paragraph 312. If the ratio of the number of links found to the number of words is more than a determined limit, the text is defined as a non-article 313. In the case where the text is defined as an article, a title is then found for the defined paragraph 314, according to font size and location in relation to the paragraph. For example, if there are a plurality of additional sentences with various font sizes, the sentence with the largest font size will typically be assumed to be the title, and will be appropriately added to the XML file as a title tab. If a picture was found in close proximity, or within, the text, the picture is then attached to the paragraph 315, according to the picture location in relation to the paragraph. The resulting location of the paragraph determines an article 316, from which the text, tile, picture and other properties are saved is separate entities within a tagged XML file.

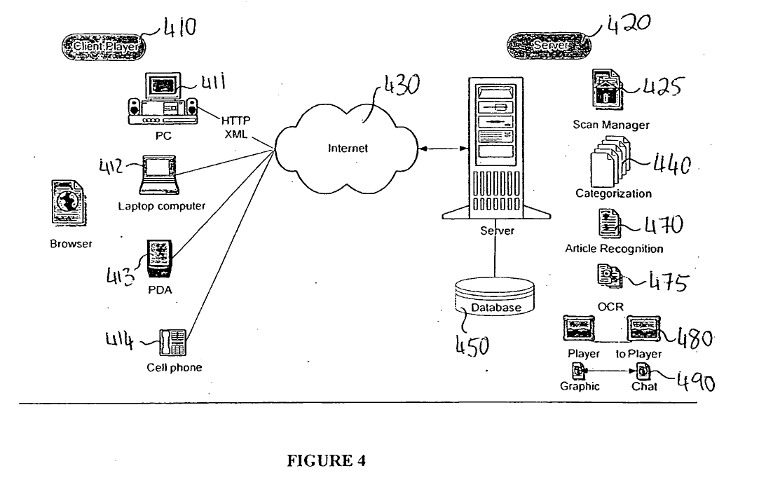

The present invention provides a basic architecture with which to execute the creation and usage of Information Graphic Objects (IGO), as described above. This can be seen with reference to FIG. 4. As can be seen in the figure, client player software 410, which may be integrated into a variety of computing and/or communications devices (such as PCs 411, laptop computers 412, PDAs 413 and cellular phones 414 etc.), is set up to function on a client computer or device. The client player software 410 includes a Basic Player Application with drawing and writing software, text extraction engine and client-based Automatic Scan Manager (ASM) software. The scan manager client software controls the automatic scan (defined tasks, filters and distribution methods). The server part open web pages automatically and extracts IGO using the ARE software. The server software 420, according to the present invention, includes the server side of the Automatic Scan Managing (ASM) system, together with an Article Recognition Engine (ARE), Automatic categorization component for IGO, and a Chat manager.

The basic player provides basic functions for creation and editing of IGO such as Free cut, Square cut, Shape cut, Text, Draw and Marker. The basic player is used to manually create IGO. The default mode is square cut, which allows the user to select square areas of content from a content source, from sources such as the Web, Word documents, presentation documents or any other format. After capturing this content, an IGO is formed that includes the captured contents text, image, title and other intrinsic properties. In addition, the system of the present invention creates a button connected to the capture, optionally with the following capabilities:

1. Save-as button saves the current IGO in the local disk (different directory)

2. Store in central server in specified category (the IGO is sent to the server).

3. Properties button allows the user to view and optionally update IGO properties.

4. Delete from desktop (local disk).

5. Icon button to minimize the IGO to the size of a small square.

6. Print button, for printing the current IGO.

7. Player to Player (PL2PL) button, for sending the IGO to one or more users (specify destination user(s) name).

8. Reply button, for sending the received IGO back to the sender.

9. Email button, that sends the current IGO to a determined email address(es).

10. Live refresh button that makes the captured IGO live, according to its refresh rate.

11. Live browser button, which makes the captured IGO live as a mini-browser window.

12. Query button that queries the system for similar information to the captured text (as in the properties).

13. Add To Chat button, for adding the current IGO to the current chat session. The Chat session must be established first.

14. Zoom button that zooms the IGO capture (using mouse).

### EXAMPLE

The user selects the square cut mode, and uses her mouse to draw the square over any information on the screen. The image under the square is captured, and an IGO is built with the basic properties (URL, text, title etc.) The IGO can be dragged & dropped on the screen, saved, deleted, chatted on, etc. Above the new capture, there is a button for controlling the capture properties. One of the features is to send the capture to other users, whereby the first user selects the other user name(s), and clicks to send the object from the screen. The user can optionally save the IGO on a central server as part of a specific category.

The chat application has text chat as well as graphical chat with other users over one or more IGO. A user creates a session and specifies the name of the session and the other users that are to be invited to join the session. A message is sent to all participants to join. After joining, each member can add IGO to the session and can graphically add text, drawings and markings over the IGO. All participants can see the changes made by any user at the same time (real time). The text script is saved for future use.

The category application is adapted to provide category definitions and queries. Category definition lets the user define an organization tree by adding and removing categories. After the tree of categories is defined, the user can get all IGO that define each category. Query lets the user query for IGO that belong to a specific category. The user can also search for IGO, either through keywords, specific text, inside the IGO or under specific categories.

Server software is set up to function on a central (company) server 420, such that the client software can connect to the server software via the Internet 430 or an Intranet. The central server 420 contains various components for the functioning of the IGO system, including: a mail server, for enabling the sending of IGO as email; a database 450, for storing system data including user profiles; a categorization application 44, for enabling the formation of personalized category trees, and enabling IGO queries and searches according to categories; a matching engine, for matching new IGO to predefined categories; Automatic Scan Manager (ASM) software 425, for executing automatic personalized content scanning; Article Recognition Engine 470, for capturing web articles or alternative content sources as IGO; an Optical Character Recognition (OCR) component 475, for recognizing content that is not automatically recognized by standard operating system software components; a Player to Player (PL2PL) component 480, for enabling real time communication of IGO between users; and a graphic chat component 490, for enabling real time collaboration between users over the same IGO.

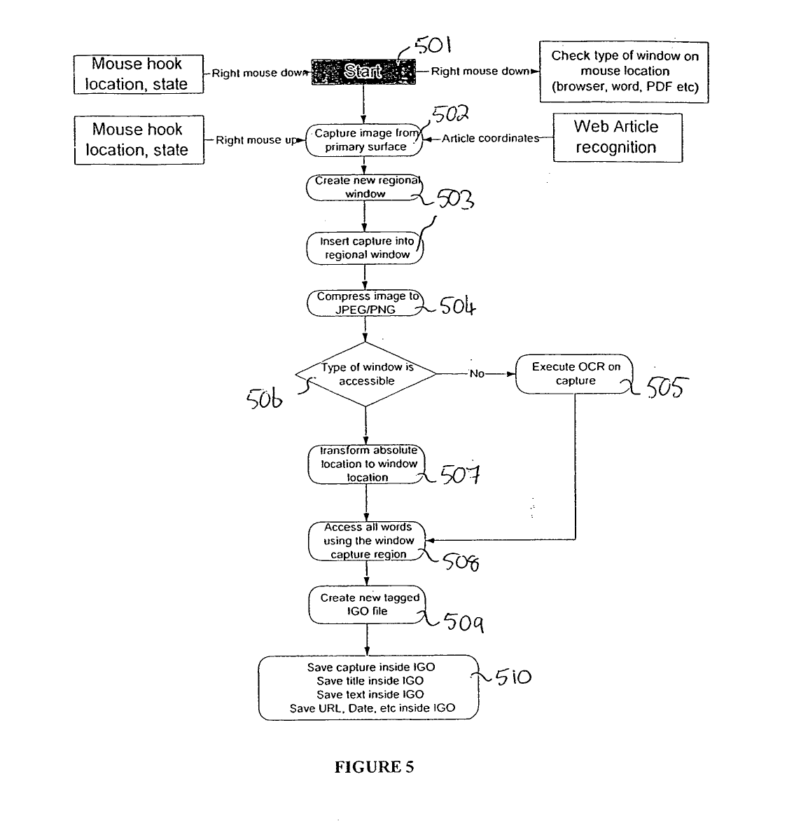

As can be seen in FIG. 5, IGO are typically created manually, according to the user's mouse location input at any given time (using system hook). The creation can utilize clicking with the mouse buttons. (typically the right-hand button), which triggers the creating of an object based on a predefined shape (square, circle, free hand etc.). In this example, the creation starts when the right mouse button is pressed (the mouse location then is taken from the system hook) 501. When the right mouse button is released (the mouse location is taken again) 502, the captured image is stored in a newly created regional window 503, which has drag and drop capabilities. At the beginning of the process, the type of the window in which the right mouse button started is verified, and subsequently, the location inside the window is transformed by having the zero location of the window on the screen. The image from the capture (which is the whole IGO, including the text, picture etc.) is subsequently compressed 504 into JPEG, PNG, GIF or any other appropriate format. If the captured window is accessible to the text recognition tool 506 using a direct connection to the application, like web browser, PDF document or word document, access to all presented textual information is automatically provided by each of these applications. In the case where the captured window is inaccessible to the text recognition tool, an off-the-shelf Optical Character Recognition (OCR) system can be incorporated, for executing 505 on the capture, in order to extract original text.

The resulting window (captured area) is transformed into relative coordinates by transforming the screen absolute location 507 that is retrieved from the mouse hook. This transformation of the captured area from an absolute location to an application (relative) location is necessary for the creation of the IGO from various types of application interfaces. Since different applications do not necessarily provide coordinates for selected areas, the present invention utilizes the absolute screen coordinates, so that the IGO accurately determines which content is captured. Therefore, upon capturing content, the type of application being used is identified, following which the fixed (absolute) screen coordinates are taken of the capture. These coordinates are then translated into coordinates of the relevant application (the data source, such as a Browser page, Word page etc.), such that the captured text at the precise location of the particular application can be extracted and used in the IGO. All words that are thus captured 508 are subsequently used as properties for a new tagged file (IGO) that is then created 509. The captured contents properties, optionally including the image, title, text, URL, date and time of capture, links etc. are subsequently stored with the IGO 510, to form a new IGO.

The extracting of the textual information is done automatically using different methods, according to the type of application being used. The method for extraction typically includes connecting to the target application either using plug-in methods or using Optical Character Recognition (OCR), when there is no way of connecting directly to the application. The plug-in methods include typical methods of text extraction based on “Get words (coordinates), GetWordfont (coordinate) and GetWordColor (coordinate). The textual result (if it exists), either from direct connecting to the target application or OCR, includes all relevant words, location of each word (window coordinates), size of each word, and color of each word, as described above. This information is stored along with the compressed image of the IGO, in a tagged file.

IGO are dynamic objects that can be shared with other users of the present invention, using the Player2 Player (PL2PL) capabilities of the system, or as email messages. These PL2PL capabilities enable IGO to be sent between various users, via the server, such that each time an IGO is captured or updated, the IGO is sent to the server, which in turn sends the IGO to the users that are taking part in the session. The IGO can be stored with their live properties. Upon extraction of an IGO from an IGO gallery (a directory in the client where all IGO are stored), the live properties become active again. Live properties, as described above, are divided into two groups, as follows: 1) actually use the location of the capture for creating the capture as a browser window. In this way one can put small capture on the screen area of the browser window (like a chart which is only updated automatically by the website); and 2) creating the capture as IGO, and repeatedly creating the IGO, using the refresh rate, to get new (fresh) data from the web site or alternative content source. The live (refresh) function enables users to maintain one or more stills pictures (from web) with refresh properties, so that any data (including prices, time, news etc.) that were in the original image will be maintained in the captured image. In this way, the captured image will ensure that the most recent information related to that capture is collected and displayed in the captured image. This component comprises opening browser control behind the live picture shape (invisible) in the same location that the capture picture is located. After the browser downloads the page completely, the capture is taken (like a camera) and the browser window is destroyed. Browser control is a window with browser properties (navigation etc.) When the page is downloaded completely and the location of the capture matches the browser location, the control becomes visible for the new capture and subsequently becomes invisible again. This task is repeated according to the refresh rate (defined by the user).

Furthermore, the present invention provides a live (Browsing) feature that builds browser objects over the captured location. In this case the browser control is not destroyed and the result is a small browser window (the size of the capture). In order to explore the entire page (like a telescope), the user uses the mouse and or another control key (like alt or arrows). An example of such a feature is information on a Website that is refreshed every x seconds. The same refreshing rate can be enabled on the relevant captured object, such that the content source for the live object provides refreshed content every x seconds. The capture can additionally function as a browser window, with movement capability over the web page. The capture thereby acts as a small browser window that can display flash, video, gif banners, links etc.

The captured images may be furthermore viewed as thumbnail images, or viewed as a list with details, such as name, URL, date/time etc. The captures can be saved to a disk file as IGO, JPEG or BMP file formats etc., or moved from the current folder to the desktop as icons. Moreover, the captured articles can enable a numerical alert function, whereby specified numeric values on any web page are tracked. The user marks the numerical value and sends the request to the server, with lower and upper limits. A New Task is built in the server to track the specified value. When the limits are exceeded, an alert object is sent to the user as a new 160 object that consists of the original IGO with the updated content of the specific value that was tracked.

IGO can be managed as dynamic objects, which are typically stored in the server database, from where they can be retrieved according to queries based on filtered parameters (such as date from, date to, category, etc). The objects can also be searched for using search string parameters, and retrieved according to key words. The search can use combination of category and search strings. Similar objects can be retrieved based on the current object's text.

Category trees can be built for each customer, on the server. The user can teach the system categories by sending specific (learning) IGO to specific categories, in order to generate a category patterns. The user, for example, just needs to send a learning IGO to a category. This IGO teaches the system how to recognize similar IGO and place them in the same category. The category accuracy is positively influenced by the number of IGO that are defined in that category.

Further features of the creation and functioning of IGO are as follows:

Mouse Control: Low-level mouse control is utilized in order to get all mouse events (state of buttons and mouse location), such that the x, y location of the system mouse can be attained at any given time. This is used for capturing, drawing, and preparing for adding text. After capturing, the captured information is left on the user output device (screen).

Capture Image and IGO: The captured picture (from primary surface) is based on the mouse location and regional window in which the image is stored. The captured image is saved as an XML file with an image tag and other properties tags, such as URL, title, text, keywords and comments etc.

There are three types of capture images: Free Cut, wherein the shape of the picture is based on free mouse movement; Square Cut, wherein the square shape of the picture is based on a mouse drag movement; and Selected shape, wherein a predefined shape can be selected (square, free form, circle etc.). At the end of the capture creating movement, when the mouse event has been completed, the shapes are automatically closed.

Captured objects may also be dragged and dropped on the user's desktop, to a gallery folder (and backed up to the desktop), or to any other client application window (such as MS-Word, MS-Power point Excel etc)

Text: The text object opens a new window at the position of the mouse click button. The window accepts alpha/numeric characters. When a user clicks with the mouse in another place (other window), referred to as lost focus, the alpha/numeric characters are stored on the picture below as separate object. The additional text item is an independent part of the IGO, and can be moved or removed as a separate entity. The text object can be moved (drag & drop) or removed. The text object is saved inside the IGO as a separate tag, and is reconstructed when the IGO is presented on the screen. In this way, the additional text may be edited independently, including updating, deleting, moving etc.

Graphic Marker: This object uses the mouse to draw transparent color markings (marker or highlighter functions) at the mouse location (free hand as well as straight lines). The resulting marks are formed as new objects. The additional marker signs are independent parts of the IGO, and can be moved or removed over the IGO as separate entities. The graphic marker object is saved inside the IGO as a separate tag and is reconstructed when the IGO is presented on the screen. In this way, the additional marking may be edited independently, including updating, deleting, moving etc.

Graphic Draw: This object uses the mouse to draw colored markings at the mouse location (free hand as well as straight lines). The line again is a new object, which can be moved to any location over the IGO or removed. The graphic draw object is saved inside the IGO as a separate tag, and is reconstructed when the IGO is presented on the screen. In this way, the additional drawing may be edited independently, including updating, deleting, moving etc.

Graphic Compress: This function is enabled using standard, off the shelf, image compressing software, which compresses, for example, BMP format to JPEG, PNG or GIF. The compressed files are stored as part of the IGO.

The graphic objects may also be edited, viewed according to zooming controls, and printed. It should be noted that the above graphic and text signs can be prepared on the screen prior to the capture creation process.

PL2PL (Player to Player): This functionality enables sending IGO objects to other users via the server. PL2PLThe resulting PL2PL object adds communication tag information into the specified IGO (XML file), which contains the captured data and all its properties (including live properties, and properties of any files from where they come). The updated XML file is sent to the server, which analyzes the destination address of the XML. A database is subsequently updated with an entry to the effect that a specific client has a new IGO ready. The next time this client is online and queries for a new IGO, the IGO file is sent to the client. The IGO may be sent to other users as IGO or email messages, and may thereby be sent to users' PDA's, mini computers and graphic-enabled mobile phones. This PL2PL object is communicated according to the following steps:

1. Adding sending information to the IGO

2. Asynchronous IGO sending (includes the PL2PL data) to a server (using XML and ASP)

3. Update the recipients with the new IGO (by the server)

4. Remove sending information from the IGO (from the server), so that the IGO remains clean without any communication parameters.

PL2PL Attachments: The PL2PL object supports attachments of files (any format from the disk directory) to the IGO. After sending the IGO via PL2PL, the user can extract the attached files to a disk directory. The Attached files are based on an XML mechanism, which contains the captured data, the properties and the attachments.

Graphic Chatting: Graphic chatting, according to an additional embodiment of the present invention, is based on HTTP protocol. The IGO is the basic component for the chat, and is the object on which the chat is executed. The chat enables a plurality of users to communicate over the same graphic object, with text and graphic signs. This function is divided between clients and server components.

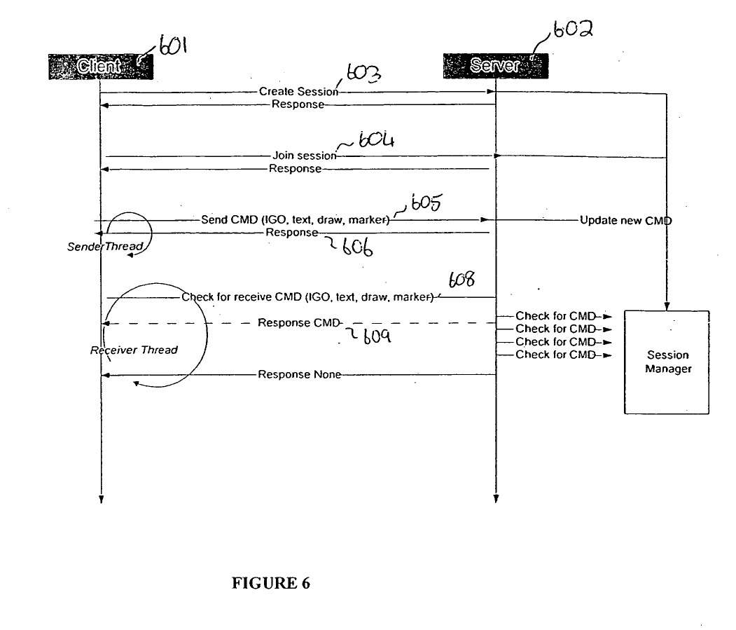

As can be seen in FIG. 6, a client 601 creates a chat session 603 and specifies the user names of users invited to the session. A message is sent to every specified user to join the chat session. Each user can select the relevant chat session and join the chat 604, using a PL2PL mechanism. After joining the session, and thereby creating a joint session (each of the users must join to the session in order to communicate in real time over the same IGO), each of the users can send a new IGO 605 (a new capture or changes to an existing capture) to the server 602, which sends 606 the IGO to the other client/s. Each connected user may edit the IGO 605, whereby each editing sign (text, marker, drawing) is sent as a command to other users, via the server, as a new IGO. The graphic chat works concurrently (in real time) over all existing graphic objects. The graphic chat can include text, marker and drawing commands, in any color, width, size and font type.

The server 602 monitors 608 the IGO on which the session is based, and upon detection of a new IGO in the session, the server 602 sends the IGO to the connected clients in real time 609. This new IGO serves to add new IGO or edit existing IGO such that the changes can be seen immediately by the other clients.

The graphic chat mechanism is enabled by transferring each command item, with item location (coordinates), to all participants as an XML object. The participant's application receives the command object, and the client application performs the command over the IGO exactly as it was done at the source. Each command is a separate object that is placed on the IGO, and can be moved or removed.

Automatic IGO Creation: According to an additional embodiment of the present invention, IGO can be created automatically. The automatic IGO creation is based on the output from an Automatic Scan Manager (ASM) system, that searches for and provides content that can be extracted by an Article Recognition Engine (ARE™).

The ASM system manages the scheduling of the automatic scan tasks. The scan task can define tasks either from specific web site or using known search engines. Each task can: contain a specific web page with a sub-link level (level 1 takes all links from the page as well); define the search string, engine name, and maximum number of results pages; and optionally provide value alert tasks for specific web pages that contain chosen numerical values (the ASM manager defines upper and lower limits values for the alert).

The ASM scheduler may create scanning tasks to be executed on a one-time basis or periodically (daily, weekly, monthly).

Filters are created by the ASM, which can be attached to the tasks. The filters contain words with logical meaning (such as and/or) and categories. Categories are predefined with learning capabilities, as described above. Every IGO created by the ARE is checked against attached filter, if the IGO passed the filter it is saved in the database inside the matched category. Each filter can be attached to many users and vice versa (each user can be attached to many filters). Every new IGO that passed all the filters is distributed to all users attached to that filter. Each user can: send the IGO using the system object (IGO) distribution system via the player, build a web page for the specified user, or send the IGO as an email.

The ASM supports matching between predefined information filters and user profiles. As such, the ASM enables automatic object distribution (alerts) for every new IGO that passes the filters and matches a chosen user profile. The result is typically a visual matched IGO from the server. The user may also reactively receive information (such as business, advertising, e-commerce) according to the matching engine. The system can alert the user of value changes (with limits) on any web page value. The result is an automatically created IGO with relevant, personalized information.

Every new IGO is automatically classified according to predefined categories. Predefine categories are defined according to a tree structure. Each category of the tree expands according to the specific IGO in this category. The process of expansion and learning is done by using statistical occurrence of words (words and weights), for all learning IGO of the specific category.

The matching engine matches new IGO to predefined categories using a statistical occurrence algorithm. If the IGO is matched with a high percentage of probability, it is joined to the specific category. If not, it is saved in the database without categorization. The matching engine supports multilingual IGO management because it uses words and weights. The matching engine is not impaired by usage of alternative languages, because the concept of each article is extracted according to the occurrence of the words (words with more occurrence are more importance to express the concept of the article and therefore these words weight more). This is true in any language.

The ARE is a software module that scans content pages from a variety of sources, according to search requests, in order to extract actual articles (and only the articles) from the page. The engine analyzes the text of the page (all the words on the page), coordinates of each word, font type (including size of words, color words, kind of font, font style etc.) width between lines, location of the text, coordinate of each picture, pictures related to articles and links exist on the page. The engine maps all words of the same structure in columns with layers. The following are the layers that the engine typically builds:

1. Body of article—Words and sentences with the same font size and within a defined spatial parameter (such as within X lines)

2. Title—Words and sentence with larger font size as titles

3. Picture—All pictures that are close to an article location (in column)

The engine tries to match each title with the body of an article, according to the location (same column and above). The same thing is done for each picture found on the page. The results of the ARE extraction procedure are typically as follows:

1. Square location (x1y1, x2y2) of any article (with images) found on the page.

2. Title of each found article

3. Text of each found article

4. Separate Images of each found article

ARE creates the IGO automatically according to the result location and the extracted text. The IGO is subsequently sent to the server for classification. Each extracted IGO (text) can be checked against the attached filters, such that if the IGO is not relevant, according to the user-defined filters, it is discarded. The ARE can also categorize any new IGO according to predefined categories, based on statistical occurrence algorithms. The ARE™ is part of the Automatic Scan Manager (ASM) system, which executes predefined tasks (see ASM).

Once the article has been captured, the generation of the IGO follows the same pattern as the manual creation process of IGO, as described above.

Automatic Scan Manager (ASM) System Flow of Operation

1. The automatic scan software (Automatic Scan Manager), according to the present invention can be downloaded from a server, or otherwise set up on a client computer.

2. Scan Tasks (based on keywords and phrases etc.) are defined using the Auto Scan Manager (ASM) software, according to at least two kinds of scan tasks: From at least one root web page with sub-link level (configure the ASM to scan pages at a determined number of links, so that the engine enters into all the links on a Web page, to the depth required); and using a search engine with a specified search string.

3. Define Scan Filters From Auto Scan Manager: Define logical strings of words (with and/or), which define the Filter. Each filter is given unique name, and each filter can be attached to one or more tasks.

4. Define Filter's Users and Distribution Type From Auto Scan Manager. The distribution method can be defined as follows: Define users attached to filters (many to many); and define user type of delivery as any combination of the following:

IGO (using system player)

Web page per filter

Email per IGO Image

5. System View Results

Use system player to receive IGO after they are created by the automatic system and the distribution system.

Use system player to query and search for archived IGO residing in the server database—the result is a query list (metadata) of names, dates and other parameters.

Use user web page (combination of user name and filter name) to view IGO images of specified scan filter.

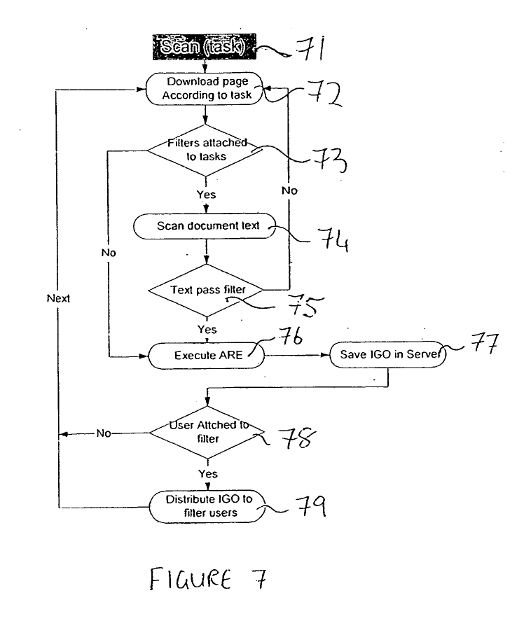

The automatic scanning process described above can be seen graphically with reference to FIG. 7. As can be seen in the figure, the ASM launches a content search based on the scan tasks 71 defined by the user. The ASM can optionally scan multiple scan tasks simultaneously. When the ASM locates matching Web pages, these pages are downloaded 72, and the ASM checks if there are filters attached to the tasks 73. If there are filters, the ASM scans and extracts the text from these pages 74, in order to be further filtered, according to the pre-configured user filters 75. The ASM can optionally execute multiple filters simultaneously. Content that has passed both the scan tasks and the filters is subsequently processed by the ARE 76, in order to extract the actual relevant articles and build IGO. Following the building of the IGO, the IGO are saved on the server 77, and the ASM checks if there is at least one user attached to the filter(s) 78. If there is, the IGO is subsequently distributed to the relevant user(s), according to the pre-configured distribution filter.

### EXAMPLE

A public-relation agency schedules a search (daily) for articles about a specific company. The search is configured by first defining the company name in the filter definition. The search is done either from a specific portal, or using search engines, and the subscriber-level of links required to scan is determined. The user then defines the distribution options (IGO, Web page, Email) attached to the filter. The first time such an IGO passes the filter, it is “sent” to the user according to the distribution options.

System Development:

The system, according to the present invention, is designed and developed based on web technology with three tiers (Client-Server). The development is based on C++ and VB COM technology. The capture is compressed using standard JPEG or PNG formats. The object (capture image+properties) with the attached files (optionally) is sent to the server (PL2PL, alert) using XML and ASP technology. The graphic chat is based http protocol only via XML/ASP). The Server is currently based on Windows-2000 server with SQL-2000 as the standard database. The client software can currently run on any PC based with windows95/98/Me/XP and Windows2000.

Alternate Embodiments

Several other embodiments are contemplated by the inventors. According to an additional embodiment of the present invention, text is extracted from the capture. This capability is used for other applications, as follows:

i. Translate the capture text (each word) as a second layer.

ii. Extracts the concept of long articles as a second layer.

iii. User Self advertising—The user can design and easily create his/her own advertising picture on his/her screen, and send it to the server for web advertisement (it will publish by location and subject classification).

iv. Creates video clip from the screen as series of captured IGO. The video clip can be shared with other users as PL2PL.

v. Security system that is supported by the alert system (track upon changes).

The foregoing description of the embodiments of the invention has been presented for the purposes of illustration and description. It is not intended to be exhaustive or to limit the invention to the precise form disclosed. It should be appreciated that many modifications and variations are possible in light of the above teaching. It is intended that the scope of the invention be limited not by this detailed description, but rather by the claims appended hereto.

What is claimed is:

1. A method for searching network based content, such that content may be located and captured from a plurality of data sources simultaneously, at a determined number of sub-link levels, according to personalized filters, comprising the steps of:
setting up Automatic Scan Manager (ASM) means;
defining a scan task using said ASM means, for scanning HTML pages;
defining scan filters using said ASNI means;
defining filters users and distribution type, using said ASM means;
searching data sources, according to configuration of said scan task, said scan filters, said filters users and said distribution type; and
presenting data content from said data sources.

2. The method of claim 1, further comprising extraction of articles from said data content, using an Article Recognition Engine.

3. The searching method of claim 1, wherein said scan task is defined according to a target selected from the group consisting of at least one web site, at least one document and at least one search engine.

4. An information graphic object (IGO) for managing network based content, comprising:
an XML file;
a compressed image; and
intrinsic content properties.

5. The IGO of claim 4, further comprising personalized object properties.

6. The IGO of claim 4, wherein said XMJL file further comprises live properties of the IGO, such that said IGO is automatically updated with refreshed content.

7. The IGO of claim 4, wherein said compressed image is stored in a file format selected from the group consisting of JPEG, PNG and GIF.

8. The IGO of claim 4, wherein said intrinsic content properties are selected from the group consisting of text, object name, title, source of content, creator, time of creation, date of creation, category data, live properties, refresh rates and links.

9. The IGO of claim 5, wherein said personalized object properties are selected from the group consisting of object name, links to other IGO, distribution data, write access, live properties, refresh rates, markings, highlights, drawings, graphic data, keywords, comments, editing dates, gallery parameters and category data.

10. A method of automatically creating information graphic objects (IGO) from information sources, comprising the steps of:
searching for specified text from at least one content source, by a content scanning means;
analyzing all relevant text from said content source, in order to establish at least one information article, by an Article Recognition Engine (ARE); and
building an IGO based on said article, by said ARE.

11. The method of claim 10, wherein said analyzing all relevant text from said content source further comprises:
extracting said relevant text from said content source, for said textual analysis; and
compiling a paragraph from said relevant text.

12. The method of claim 11, wherein if there is an image in proximity to said relevant text, extracting said image and attaching said image to said paragraph.

13. The method of claim 11, wherein said extracting relevant text comprises a procedure selected from the group consisting of direct text recognition and Optical Character Recognition (OCR).

14. The method of claim 11, wherein said compiling a paragraph from said selected text further comprises:
extracting all words from said relevant text;
connecting said extracted words to form sentences, according to location of said words;
analyzing location and type of each said sentences;
arranging all said sentences of same said location and same said type, wherein said sentences are contiguous, into single paragraphs; and
identifying a title for said defined paragraph, according to said location and type of at least one sentences that is dissimilar in type.

15. The method of claim 14, further comprising checking the ratio of the number of links found in said paragraph to the number of words in said paragraph, in order to confirm that said paragraph is a legitimate paragraph.

16. The method of claim 14, further comprising checking the number of lines in said paragraph, such that a paragraph with a number of lines below a determined threshold is considered an illegitimate paragraph.

17. The method of claim 14, wherein said sentence type is selected from the group consisting of font size, font color, font properties, font style and kind of font.

18. The method of claim 10, wherein said building an IGO further comprises:
creating a tagged XML file from said information article, said XML file including text, title and intrinsic properties of said article.

19. The method of claim 18, wherein if there is an image, adding said properties of said image to said XML file.

20. The method of claim 18, further comprising adding personalized properties to said XML file.

21. A method for creating information graphic objects (IGO) from information sources, comprising the steps of:
selecting an area of content from a content source, by a user;
extracting text, title and intrinsic properties from said content automatically; and
forming an IGO based on a tagged XML file, said file incorporating at least said text, said title and said intrinsic properties of said content, as tags for said XML file.

22. The method of claim 21, wherein said extracting text comprises a procedure selected from the group consisting of direct text access and Optical Character Recognition (OCR).

23. The method of claim 21, wherein said IGO further comprises personalized properties of said content.

24. A method for enabling real time graphic chatting between a plurality of users, comprising:
establishing a chat session between at least two users;
creating an IGO and determining recipients for said IGO, by a first user;
sending said IGO to said determined recipients in real time, by a server;
monitoring said IGO for changes made by users; and
upon detection of a change in said IGO, sending said change to said connected recipients in real time, by said server.

25. The method of claim 24, wherein said chat session is expanded to operate on a plurality of IGO.

26. The method of claim 24, wherein said changes made by users are selected from the group consisting of textual changes, graphic changes, highlights, markings and voice comments, such that said changes being made by at least one user are immediately viewable by all users.

27. The method of claim 26, wherein each said change is a separate entity of said IGO, such that said change can be edited independently.
